(19) United States
(12) Patent Application Publication
(10) Pub. No.: US 2025/0342024 A1
(43) Pub. Date: Nov. 6, 2025

(54) PROVISIONING VEHICLE APPLICATION TO AN IN-VEHCILE INFOTAINMENT SYSTEM TO SUPPORT USER DEVICES DETECTED IN A VEHICLE

(71) Applicant: TOYOTA JIDOSHA KABUSHIKI KAISHA, Aichi-ken (JP)

(72) Inventor: Boris Kurtis BIGNUMB-BI-KUMB, Tokyo-to (JP)

(21) Appl. No.: 18/652,763

(22) Filed: May 1, 2024

(51) Int. Cl. G06F 8/61

(52) U.S. Cl. CPC G06F 8/61

(57) ABSTRACT

A method, vehicle information system, and non-transitory computer-readable media. A device is detected in a vehicle. In response to detecting the device in the vehicle, an application is provided to an In-Vehicle Infotainment (IVI) system to collect information and provide a service to a user based on the collected information. The information collected from the detected device by the application provisioned to the IVI system is received. In response to receiving the information, an action is automatically triggered by the IVI system for the service based on the information collected by the application.

### TECHNICAL FIELD

This description relates to provisioning vehicle applications to an in-vehicle infotainment (IVI) system to support user devices detected in a vehicle, and method of using the same.

### BACKGROUND

There are currently new vehicles that have sensors and different equipment for gathering data about the vehicle and the driver. Fleet management systems enable fleet operators to monitor and manage the fleets of vehicles, including tracking fuel consultation, optimizing routes, and scheduling maintenance to improve efficiency and reduce costs. Additionally, cloud-connected IoT (Internet-of-Things) boxes link to telematics devices to offer real-time data on driver health and vehicle status. These systems share statistics on driver performance and health, detect drowsiness, and send idle alarms.

Wearable technology has also been on the rise and one of the most popular forms of wearable technology is fitness bands, watches, smart rings, and trackers, which record and report on a user's activity, location, and biometric data. Integrating wearable technology into the connected car is able to provide a number of benefits to the driver and the passengers in the areas of safety, infotainment experiences, and more.

Vehicles currently are unable to acquire or collect some information from such sensors and equipment. For example, an In-Vehicle Infotainment (IVI) System (also referred to as simply Infotainment System) is able to detect and pair with wearable technology using wireless communications, e.g., Bluetooth. However, a vehicle is not technically able to gather precise or detailed information from the wearable device of the user because the vehicle does not have the sensors or the proper precise algorithm for identifying and connecting to user devices. A wearable device is able to obtain information relevant to the state of the user and the environment, but is not configured for communicating with the infotainment system to provide the relevant information. The vehicle is thus unable to collect information from the wearable devices of the user and to use the information to provide a natural experience inside the vehicle or an actual application inside the vehicle.

### SUMMARY

In at least embodiment, a method for provisioning an application to an In-Vehicle Infotainment (IVI) system in a vehicle includes detecting a device in the vehicle, in response to detecting the device in the vehicle, provisioning an application to an IVI system to collect information from the detected device and provide a service to a user based on the collected information, receiving the information collected from the detected device by the application provisioned to the IVI system, and in response to receiving the information, automatically triggering by the IVI system an action for the service based on the information collected by the application from the detected device.

In at least one embodiment, a vehicle information system includes a memory storing computer-readable instructions, and a processor connected to the memory, wherein the processor is configured to execute the computer-readable instructions to perform operations to detect a device in the vehicle, in response to detecting the device in the vehicle, provision an application to collect information from the detected device and provide a service to a user based on the collected information, receive the information collected from the detected device by the application provisioned to collect the information from the detected device, and in response to receiving the information, automatically trigger an action for the service based on the information collected by the application from the detected device.

In at least one embodiment, a non-transitory computer-readable media having computer-readable instructions stored thereon, which when executed by a processor causes the processor to perform operations including detecting a device in the vehicle, in response to detecting the device in the vehicle, provisioning an application to an In-Vehicle Infotainment (IVI) system to collect information from the detected device and provide a service to a user based on the collected information, receiving the information collected from the detected device by the application provisioned to the IVI system, and in response to receiving the information, automatically triggering by the IVI system an action for the service based on the information collected by the application from the detected device.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a vehicle cockpit according to at least one embodiment.

FIG. 2 is a block diagram of the System for detecting a user device in a vehicle to provide an application for collecting information from the detected user device according to at least one embodiment.

FIG. 3 illustrates a process for pairing a device according to at least one embodiment.

FIG. 4 illustrates a flow chart of a method for monitoring a state of customer devices according to at least one embodiment.

FIG. 5 illustrates an In-Vehicle Infotainment (IVI) GUI for obtaining Customer Services according to at least one embodiment.

FIG. 6 illustrates an Application Store GUI upon accessing the application store according to at least one embodiment.

FIG. 7 illustrates an In-Cabin Application GUI according to at least one embodiment.

FIG. 8 is an Ring Wearable Device GUI according to at least one embodiment.

FIG. 9 is an Ring Wearable Device 1234568 GUI according to at least one embodiment.

FIG. 10 is an application Description GUI according to at least one embodiment.

FIG. 11 is a flowchart of a method for provisioning an application to an In-Vehicle Infotainment (IVI) for collecting information from a device detected in a vehicle according to at least one embodiment.

FIG. 12 is a high-level functional block diagram of a processor-based system according to at least one embodiment.

### DETAILED DESCRIPTION

Embodiments described herein describe examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming or signaling-streaming. The foregoing terms are utilized interchangeably in the subject specification and related drawings.

In at least one embodiment, a method for provisioning an application to an In-Vehicle Infotainment (IVI) system in a vehicle includes detecting a device in the vehicle, in response to detecting the device in the vehicle, provisioning an application to an IVI system to collect information from the detected device and provide a service to a user based on the collected information, receiving the information collected from the detected device by the application provisioned to the IVI system, and in response to receiving the information, automatically triggering by the IVI system an action for the service based on the information collected by the application from the detected device.

Embodiments described herein provide one or more advantages. For example, by detecting a user device in a vehicle and provisioning an application to an IVI system, the user device is able to be configured for communicating with the IVI system via the application and to collect information to enable an IVI system to provide a natural experience inside the vehicle, such as sending a notification to the user in response to determining the user is falling asleep, adjusting the temperature in the vehicle to a more comfortable level, making automatic payments, and the like.

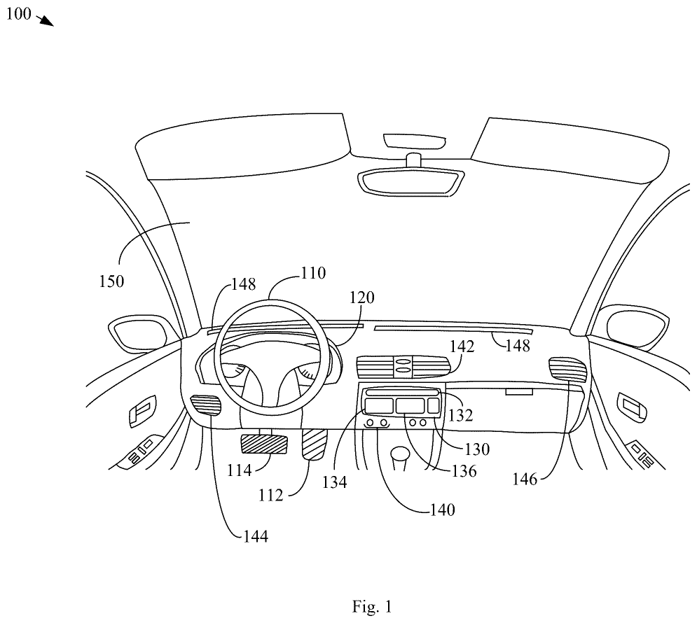

FIG. 1 illustrates a vehicle cockpit 100 according to at least one embodiment.

In FIG. 1, the vehicle cockpit includes Steering Wheel 110, Accelerator Pedal 112, Brake Pedal 114, Instrument Panel 120, Infotainment System 130, and Climate Control System 140. Climate Control System 140 is also sometimes referred to as the Heating, Ventilation, and Air Conditioning (HVAC) System. The Steering Wheel is the part of the steering system that is manipulated by the driver to control the steering system and the direction of the vehicle. By manipulating the Steering Wheel 110 the driver directs the direction of the vehicle through a linkage system to the front wheels. The Accelerator Pedal 112 is used to control fuel and air supply to the engine by application of pressure. Accelerator Pedal 112 is also known as the throttle or gas pedal. The Brake Pedal 114 is pressed to apply the brakes, which cause the vehicle to slow down and/or stop.

Instrument Panel 120 is the portion of the dashboard which is positioned behind the Steering Wheel 110. The Instrument Panel 120 includes various gauges and lights that update the driver on the status of the vehicle. For example, Instrument Panel 120 often includes traction control indicators, engine temperature, tachometer, a fuel gauge, a speedometer, an odometer, turn indicators, gear display, various warning lights, and the like. The tachometer displays the rotation of the engine's crankshaft in revolutions per minute (RPM). The speedometer shows the speed of the vehicle. The odometer shows you the total number of miles traveled since you started driving the car. The fuel gauge shows you how much fuel is left in the vehicle. The temperature gauge indicates the current engine temperature. Alternatively, a designated light is able to be included to warn about engine temperature issues, such as engine overheating. Turn indicators represent flashing lights on either side of the vehicle to communicate to other drivers the direction that the driver intends to turn. A gear display or gear position indicators shows the gear that is currently engaged, e.g., park, neutral, drive, and the like. Warning lights communicate different status items of the vehicle. Vehicles have various features like ESC and ABS pre-installed, not to mention the more standard components or elements. Warning lights are illuminated briefly upon startup as the vehicle checks to ensure the systems are safe and ready for operation. Occasionally one warning light might stay on, indicating a problem, e.g., the engine, headlights, temperature, and the like.

Infotainment System 130 is a combination of information plus entertainment. An Infotainment System 130 is a collection of hardware and software in vehicles that provides audio and video entertainment/information. Infotainment System 130 provides an information system for obtaining information regarding different aspects of the vehicle, e.g., from one or more Electronic Control Units (ECUs) and for interacting with systems of the vehicle, e.g., pairing of Bluetooth devices, setting up devices (e.g., user devices and vehicle devices), and the like. According to at least one embodiment, Infotainment System 130 presents a User Interface for a menu that enables the vehicle to detect user devices and to set up user devices to provide services using the user devices. For example, the vehicle is able to obtain information from detected user devices, such as monitoring precisely and in real-time the user's health, sleep status, and the like. This information is relevant to the experience inside the vehicle.

The User Interface is able to present a Title Bar 132 that provides an indicator of the current menu. Menu options 134, 136 are presented for selection to set up user devices to provide services using the user devices. Climate Control System 140 includes controls for setting the temperature of the interior of the vehicle and for setting operation of the Climate Control System 140, e.g., air conditioning, heating, defrosting, floor vents, defrost vents, occupant vents, and combinations thereof. For example, vents that are located at different positions in the vehicle, e.g., vent 142 for providing central air flow, vent 144 for proving air flow toward the driver, vent 146 for providing air flow toward a passenger, and vent 148 on the top of the dash for defrosting the windshield 150. Additional vents are able to be positioned in different areas of the vehicle, e.g., in the back seat area, underneath the dash, and the like.

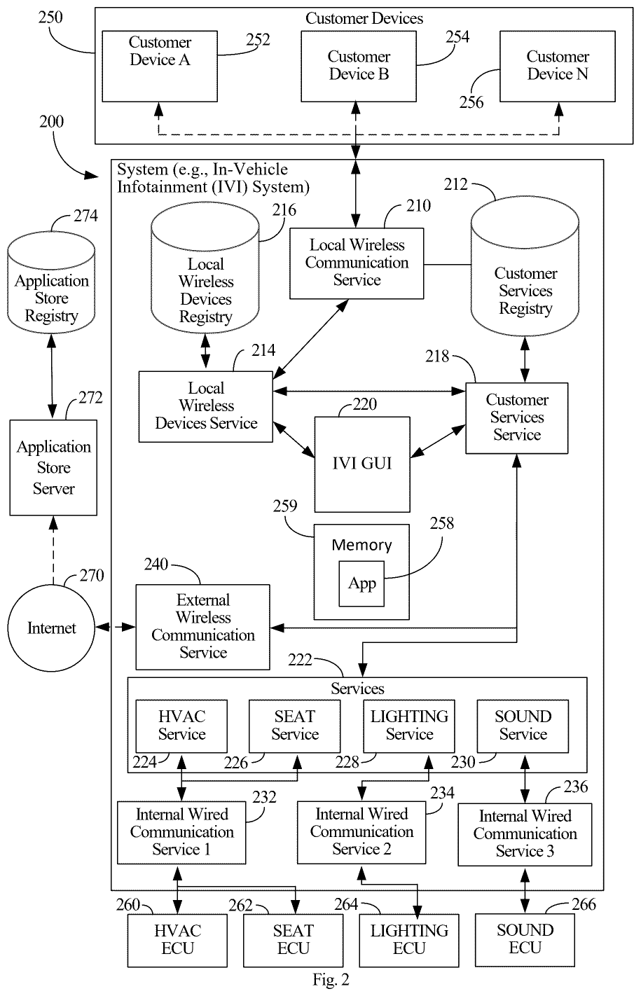

FIG. 2 is a block diagram of the System 200 for detecting a user device in a vehicle to provide an application for collecting information from the detected device according to at least one embodiment.

In FIG. 2, the System 200 is implemented in an In-Vehicle Infotainment (IVI) System, which herein is also referred to as an information system. System 200 includes a Local Wireless Communication Service 210 that communicates with Customer Devices 250, such as Customer Device A 252, Customer Device B 254, and Customer Device N 256. Such devices include Health Wearable Devices, Artificial Intelligent (AI) Pins, Sport Wearable Devices, Multipurpose Wearable Devices, Ring Wearable Devices, and the like.

System 200 detects the presence of user devices, such as after a user enters the vehicle, and installs an appropriate Application 258 for Customer Devices 250 in memory 259 of System 200. Customer Device A 252 is able to then provide information to System 200 for different services. For example, a user entering a vehicle with Customer Device A 252 is able to provide information that is useful, e.g., sleep status or the temperature of the driver or passenger. After the System 200 is set up, e.g., by being provided an appropriate Application 258, a device is able to connect to the System 200. Without the provisioning of the appropriate Application 258 to System 200, System 200 is unable to obtain information from Customer Device A 252 to control Services 222 accordingly.

Local Wireless Communication Service 210 communicates with a Local Wireless Devices Service 214. Local Wireless Devices Service 214 communicates with a local device registry, e.g., Local Wireless Devices Registry 216. Local Wireless Devices Service 214 also communicates with a service, e.g., Customer Services Service 218. Local Wireless Devices Service 214 and Customer Services Service 218 communicate with System 200. In-Vehicle Infotainment (IVI) Graphic User Interface (GUI) 220 facilitates communication with a user.

Customer Services Service 218 communicates with Services 222. Services 222 includes different vehicle services such as Heating, Ventilation, and Air Conditioning (HVAC) Service 224, SEAT Service 226, LIGHTING Service 228, SOUND Service 230, and the like. HVAC Service 224 and SEAT Service 226 communicate with HVAC Electronic Control Unit (ECU) 260 and Seat ECU 262, respectively, through Internal Wired Communication Service 1 232. However, those skilled in the art recognize that other types of communication services are able to be used. LIGHTING Service 228 communicates with LIGHTING ECU 264 through Internal Wired Communication Service 2 234. SOUND Service 230 communicates with SOUND ECU 266 through Internal Wired Communication Service 3 236.

Customer Services Service 218 communicates with External Wireless Communication Service 240. External Wireless Communication Service 240 accesses a network, e.g., Internet 270. Customer Services Service 218 accesses an Application Store Server 272 via External Wireless Communication Service 240, and Internet 270. Application Store Server 272 communicates with an Application Store Registry 274.

Accordingly, System 200 is able to install Application 258 in Memory 259 so that System 200 is able to execute Application 258 to interface with Customer Devices 250, e.g., Customer Device A 252. For example, System 200 is able to monitor the sleep state of a user by accessing information received from Customer Device A 252, for example, using Application 258. The Application 258 is able to receive information from Customer Device A 252, wherein System 200 is then able to trigger an alarm, vibration, or other notification based on the received information. Thus, in response to a driver being determined to be sleeping, the Customer Device A 252 is able to provide information to the Application 258 installed in System 200. In response to the temperature of the customer or the internal environment of the cockpit of the vehicle becoming too hot, an automatic trigger is able to be sent to the HVAC ECU 260 to adjust the temperature.

After a user enters the vehicle, a Local Wireless Communication Service 210 pairs with Customer Devices 250, such as Customer Device A 252, Customer Device B 254, and Customer Device N 256 using wireless communication mechanisms, such as Bluetooth and the like. Customer Device A 252 registers with the vehicle at least once. The next time Customer Device A 252 is detected, Customer Device A 252 is recognized and paired automatically via Bluetooth. However, those skilled in the art understand that other communication protocols are capable of being used.

System 200 detects at least one of Customer Device A 252, Customer Device B 254, and Customer Device N 256, and the Local Wireless Devices Service 210 begins to handle the Customer Device A 252, Customer Device B 254, and Customer Device N 256 using Local Wireless Devices Service 214. Local Wireless Devices Service 214 detects whether the detected Customer Device A 252 is already paired with System 200 by accessing a Local Wireless Devices Registry 216.

In response to Customer Device A 252 not already being paired with System 200, the IVI GUI 220 is notified by the Local Wireless Devices Services 214 that a new device is ready to be paired. The user then uses IVI GUI 220 to pair Customer Device A 252 with System 200. Customer Device A 252 identifies itself to System 200 using certain information. Ideally a communication protocol that devices conform to is used so that when Customer Device A 252 connects, Customer Device A 252 is able to announce the connection in a predetermined format so that the vehicle immediately recognizes what that information represents and how to utilize that information in the execution of existing applications. This provides System 200 the ability to collect different information from multiple devices. However, according to at least one embodiment, the communication of the information is a function of the application and is limited to a single device.

Once Customer Device A 252 is paired with System 200, information is collected by the Application 258. Based on the received information, System 200 is able to trigger some type of automation for the convenience and safety of the user. Through interface with System 200, Application 258 collects information from Customer Devices 250. For example, the device application matching a particular one of Customer Devices 250 is able to be installed in System 200 to communicate and interact with the corresponding Customer Devices 250 to collect data and provide a service to a user.

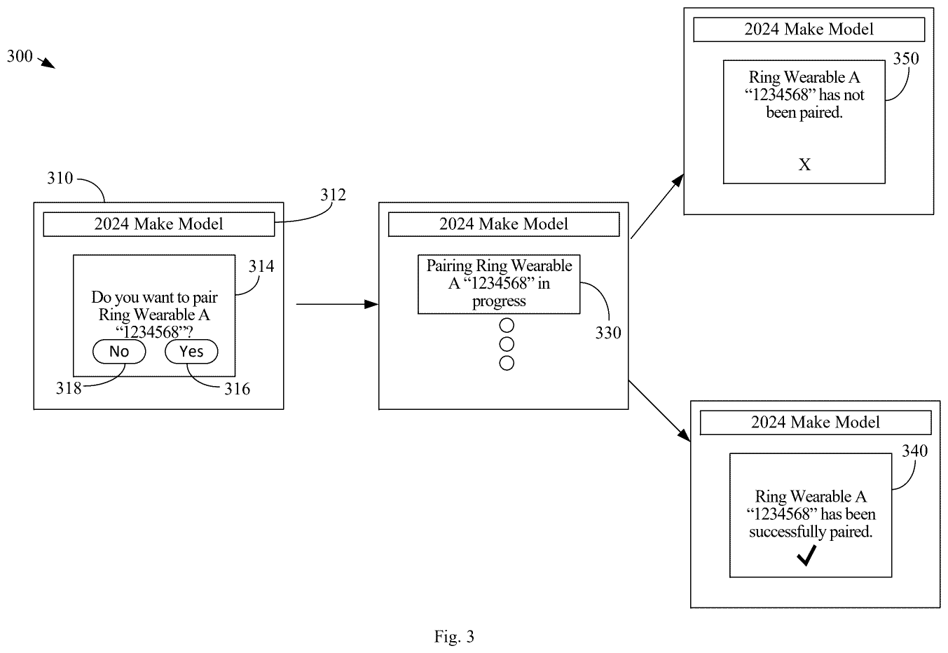

FIG. 3 illustrates a process 300 for pairing a device according to at least one embodiment.

In FIG. 3, a first prompt 310 is presented having a Banner 312 identifying the type of vehicle, e.g., 2024 Make Model. Prompt 310 presents a Query 314 asking the user whether the user wants to pair a user device, such as Ring Wearable A “1234568” and presents a Yes option 316 and a No option 318. Upon selection of the Yes option 316, a Pairing Status Indicator 330 is displayed. In response to successful pairing of Ring Wearable A “1234568”, a Confirmation 340 is displayed. In response to successful pairing of Ring Wearable A “1234568”, a Failure to Pair 350 is displayed.

Referring back to FIG. 2, Customer Services Service 218 is triggered following the detection (newly paired or not) of at least one of Customer Devices 250. Once a device is detected or paired, System 200 is able to be triggered to present options for Services 222 based on information collected by Application 258 from Customer Devices 250. The brands of Customer Devices 250 and the device applications are presented to the user. The System 200 is able to present different device applications based on the Customer Devices 250 because the vehicle gathers the information about the registered device, e.g., the device is Sport Wearable model X. For example, the System is able to access a database that associates different devices and different vehicle models with compatible device applications that are compatible.

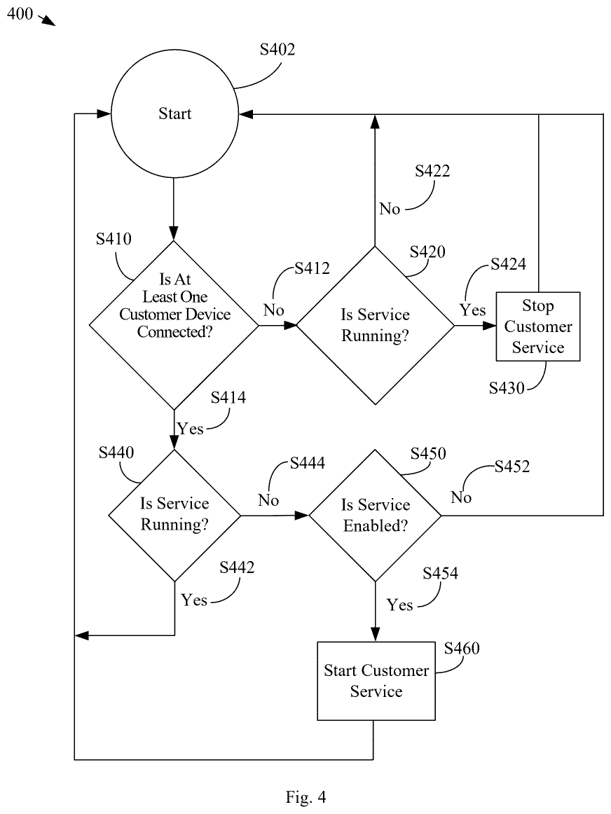

FIG. 4 illustrates a flow chart 400 of a method for monitoring a state of customer devices according to at least one embodiment.

In FIG. 4, Customer Services Service monitors the state of customer devices in order to start or stop Customer Services. The method starts S402 and a determination is made whether at least one customer device is connected S410. In response to determining that at least one customer device is connected S412, a determination is made whether a service is running S420. In response to determining the service is not running S422, the process returns to Start S402. In response to determining the service is running S424, the Customer Service is Stopped S430 and the process returns to Start S402.

In response to determining that at least one customer device is connected S414, a determination is made whether the service is running S440. In response to determining the service is running S442, the process returns to Start S402. In response to determining the service is not running S444, a determination is made whether the service is enabled S450. In response to determining the service is not enabled S452, the process returns to Start S402. In response to determining the service is enabled S454, the Customer Service is Started S460. The process then returns to Start S402.

Referring to FIG. 2, System 200 interfaces with vehicle Services 222, such as HVAC Service 224, SEAT Service 226, LIGHTING Service 228, SOUND service 230, and the like. System 200 is able to communicate with Electronic Control Units (ECUs) that monitor and control such services. System 200 enables the user to pair particular Customer Devices 250 with System 200 and to present a status of the pairing process to the user via IVI GUI 220. System 200 is able to stop services that are running but that are not connected, and to start services that are enabled but not running.

In FIG. 2, IVI GUI 220 is used by the user in the vehicle to obtain Customer Services. In response to the installation of an application being selected, the application is downloaded and installed. Customer Services Service 218 accesses Application Store Server 272 through the Internet 270 using External Wireless Communication Service 240. Application Store Server 272 uses Application Store Registry 274 to present the proper Application 258 in Application Store Server 272 and transfer the data in response to the Application 258 being requested. Application 258 is downloaded to Memory 259 and Customer Services Service 218 registers the Application 258 with Customer Services Registry 212. Customer Services Registry 212 communicates the registered application to Local Wireless Communication Service 210.

In some situations, Customer Devices 250 and the system do not share the same language and protocol in order to communicate. However, the system is configured to recognize the capabilities being communicated by the Customer Devices 250. In such situations, some human intervention is used to curate the list of applications per device to make sure that device applications that were tested and proven are presented to the user. This prevents random device applications from being downloaded to Memory 259. The downloading of random device applications is problematic for security reasons and other reasons. Thus, developers of device applications are recognized and follow the rules about how the device applications are to be developed.

For applications that are to be provided by Application Store Server 272, actual APIs or SDKs are provided to the developers to support services for such applications in Application Store Server 272. The information is provided to recognized developers because the SDK is not open or accessible to everyone. For the Customer Devices 250, information is provided in the SDK to determine which developers are included in the developer list.

In response to accessing the Application Store Server 272, System 200 identifies the vehicle along with a device of interest. System 200 requests the information compatible with the present environment. System 200 takes into account the Customer Devices 250 that are paired with the System 200 so that the Application Store Server 272 provides to System 200 the Application 258 that matches the current configuration.

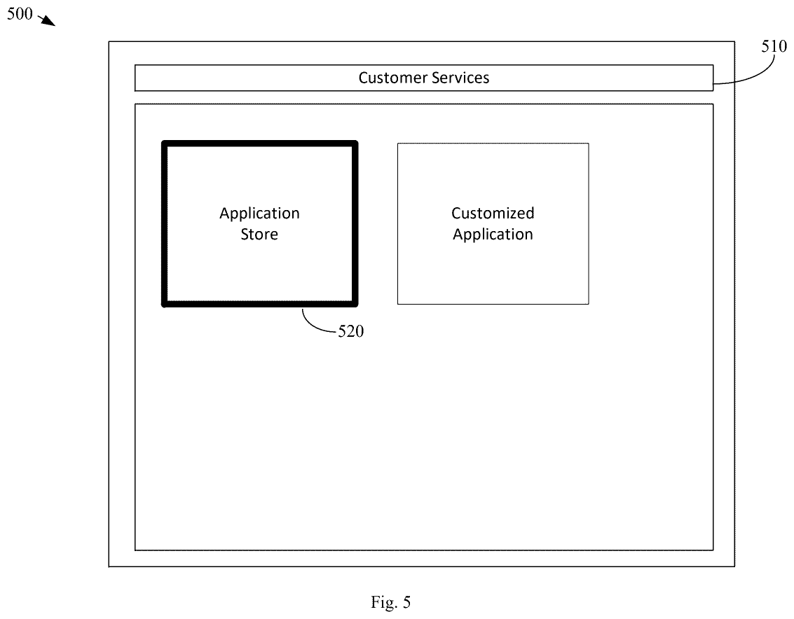

FIG. 5 illustrates an In-Vehicle Infotainment (IVI) GUI 500 for obtaining Customer Services according to at least one embodiment.

In FIG. 5, IVI GUI 500 is displayed with a Banner 510 identifying methods for obtaining an application for use by the IVI system for providing information in support of at least one service. A Selection for accessing an Application Store 520 is presented in IVI GUI 500. Upon selection to access the Application Store 520, the system connects to the application store server for downloading applications into memory of the system for execution by the system to collect information from customer devices. Customer devices are registered along with associated services.

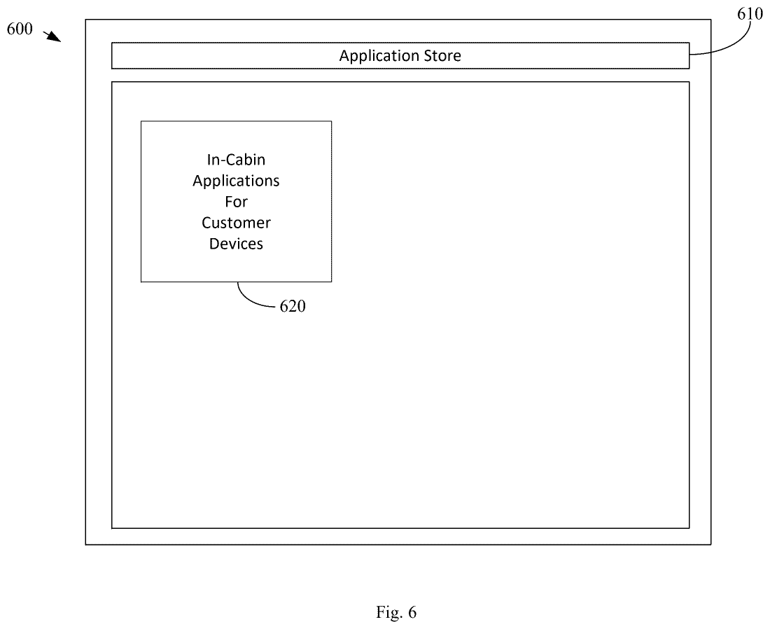

FIG. 6 illustrates an Application Store GUI 600 upon accessing the application store according to at least one embodiment.

In FIG. 6, Application Store GUI 600 includes a Banner 610 identifying the interface being associated with the Application Store. Application Store GUI 600 also provides access to In-Cabin Applications for Customer Devices 620.

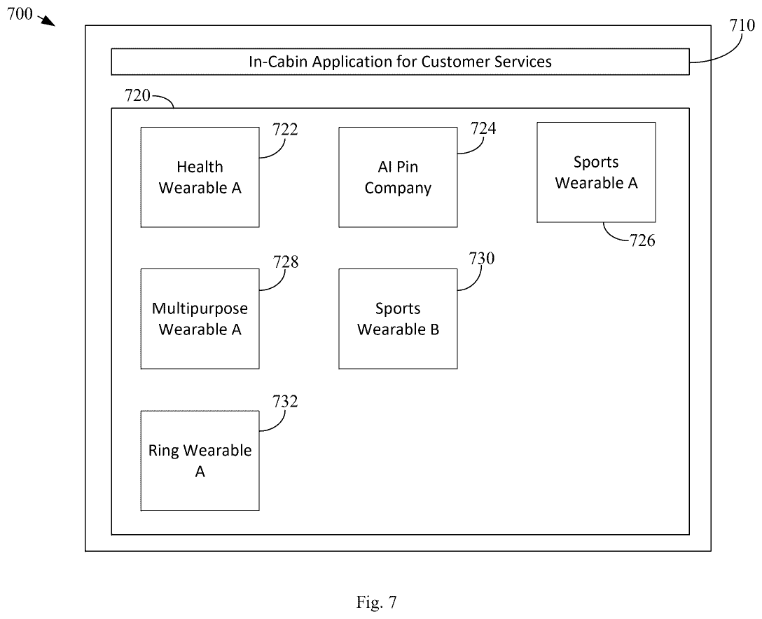

FIG. 7 illustrates an In-Cabin Application GUI 700 according to at least one embodiment.

In FIG. 7, a Banner 710 is presented identifying GUI 700 as listing In-Cabin Applications for Customer Devices. In-Cabin Application GUI 700 provides an Interface That Lists Third-Party Developers 720, wherein the customer is able to select an application associated with the Customer Services for downloading to the user device. In FIG. 7, Health Wearable Devices 722, Artificial Intelligent (AI) Pins 724, Sport Wearable Devices A 726, Multipurpose Wearable Devices 728, Sprot Wearable Devices B 730, Ring Wearable Devices 732, and the like are listed. Those skilled in the art understand that more than one type of device is able to be listed, e.g., Sport Wearable Devices A 726 and Sport Wearable Devices B 730, or certain types of devices are able to not be included in the list.

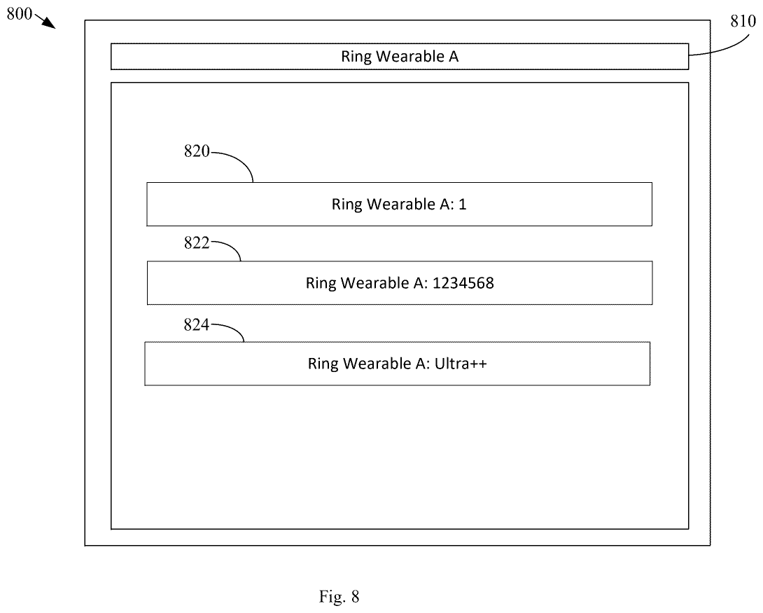

FIG. 8 is a Ring Wearable Device GUI 800 according to at least one embodiment.

In FIG. 8, Ring Wearable Device GUI 800 is displayed after Ring Wearable Device A 732 in FIG. 7 is selected by the user. Ring Wearable Device A GUI 800 includes Banner 810 identifying the Ring Wearable Device A GUI 800 and provides a list of Customer Devices in order for the user to be able to select the right one. For example, after selecting Ring Wearable Device A 732 in FIG. 7 as the device of interest, Ring Wearable Device A GUI 800 provides a list of Customer Devices, such Ring Wearable Device A 1 820, Ring Wearable Device A 1234568 822, and Ring Wearable Device A Ultra++ 824. Developers are able to add or delete Customer Devices as circumstances change, e.g., a customer device being phased out or a new customer device being developed.

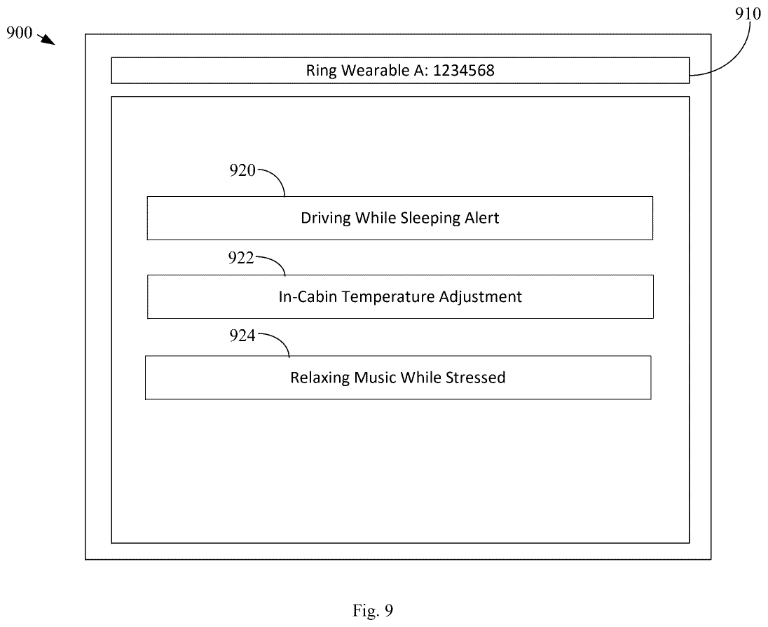

FIG. 9 is a Ring Wearable Device 1234568 GUI 900 according to at least one embodiment.

In FIG. 9, Ring Wearable Device 1234568 GUI 900 is displayed after Ring Wearable Device 1234568 822 in FIG. 8 is selected by the user. Ring Wearable Device 1234568 GUI 900 includes Banner 910 identifying Ring Wearable Device 1234568 GUI 900. Ring Wearable Device 1234568 GUI 900 displays applications associated with Ring Wearable Device 1234568, such as Driving While Sleeping Alert 920, In-Cabin Temperature Adjustment 922, Relaxing Music while Stressed 924, and the like. From Ring Wearable Device 1234568 GUI 900, the user selects the application that the third party-developer has created for a particular product and the device application that the third party-developer has created for this selected device. The application is executed by the IVI system to collect the data provided by the corresponding customer device, e.g., Ring Wearable Device 1234568.

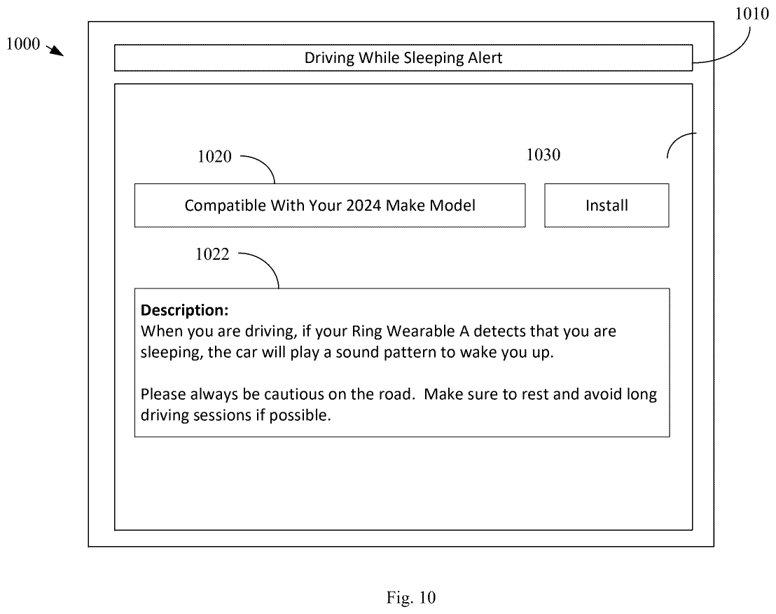

FIG. 10 is an application Description GUI 1000 according to at least one embodiment.

In FIG. 10, Application Description GUI 1000 is displayed after Driving While Sleeping Alert Application 920 in FIG. 9 is selected by the user. Driving While Sleeping Alert

Application Description GUI 1000 includes Banner 1010 identifying the application being for Driving While Sleeping Alert. Application Description GUI 1000 a Compatibility Status 1020. Compatibility Status 1020 indicates that the application is compatible with a 2024 Make Model. Application Description GUI 1000 includes Description 1022. Description 1022 indicates that “When you are driving, if your Ring Wearable 1234568 detects that you are sleeping, the car will play a sound pattern to wake you up. Please always be cautious on the road. Make sure to rest and avoid long driving sessions if possible.” Application Description GUI 1000 further includes an Install button 1030 for the user to select to download and install the application in the IVI system. In response to the Install button 1030 being selected, the device application is downloaded and installed on the IVI system for collecting data from Ring Wearable Device A 1234568 of the user.

Referring to FIG. 2, System 200 recognizes the Customer Devices 250 and the device applications that correspond to a particular customer device. Based on the copy SDK, APIs, and the like, third-party developers are able to develop device applications to target some type of background service inside the vehicle to trigger the automation that the developer wants to provide to the customer. Other services are able to be implemented besides sleep state monitoring and alerts, temperature determination and adjustments, and the like. For example, automatic payments are able to be supported, where a user wearing a smart watch enters a taxi and the taxi automatically detects the smart watch. The taxi has the device application installed and a payment is made automatically at the end of the route.

Developers have the capability to create automations because the device manufacturers have ideas about the proper device applications to implement. However, customers or users of the Customer Devices 250 know more about the type of interaction the users want. Thus, according to at least one embodiment, users are able to access the Application Store Server 272 to obtain a device application and install the device application in Memory 259, and other ways to create device applications manually are able to be used. For example, a predetermined protocol could be developed so that a device is able to indicate the type of information that the device is capable of providing. The customer is then able to create the interactions that the customer actually wants and the Application 258 provides the customer the opportunity to create its own automation.

The Customer Services Service 218 executes the Application 258 and communicates with the targeted service. Customer Services Service 218 executes the Application 258 and communicates appropriately with a targeted service. Customer Services Service 218 checks whether the Application 258 is compatible with at least one of Customer Devices 250 and with the kind of vehicle associated with the at least one of Customer Devices 250. For example, the Application 258 is to be compatible with the device and also with the vehicle in terms of APIs and the like. For example, Application 258 communicates with Local Wireless Communication Service 210. Local Wireless Communication Service 210 communicates with Local Wireless Devices Service 214. Wireless Devices Service 214 communicates with Customer Services Service 218, wherein Customer Services Service 218 check with Customer Services Registry 212 to determine whether the Application 258 has been registered. Upon confirming that the Application 258 is registered with Customer Services Registry 212, Customer Services Service 218 sends an automatic trigger to the HVAC Service 224 which communicates with HVAC ECU 260 through Internal Wired Communication Service 1 232 to adjust the temperature.

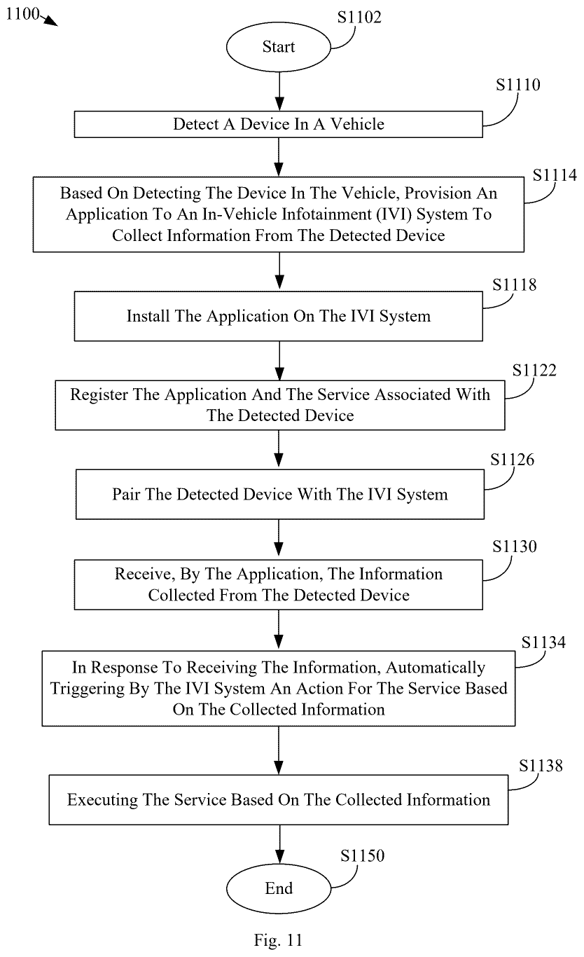

FIG. 11 is a flowchart 1100 of a method for provisioning an application to an In-Vehicle Infotainment (IVI) for collecting information from a device detected in a vehicle according to at least one embodiment.

In FIG. 11, the method starts S1102 and at least one user device is detected in a vehicle S1110. Referring to FIG. 2, System 200 detects the presence of user devices, such as after a user enters the vehicle, and installs an appropriate Application 258 for Customer Device A 252 in Memory 259 of System 200. Customer Device A 252 is able to then provide information to System 200 for different services.

Based on detecting the at least one user device in the vehicle, an application is provided to an In-Vehicle Infotainment (IVI) System to collect information from the detected device S1114. Referring to FIG. 2, once a device is detected or paired, System 200 is able to be triggered to present options for Services 222 based on information collected by Application 258 from Customer Devices 250.

The application is installed on the IVI System S1118. Referring to FIG. 2, Application 258 collects information from Customer Devices 250. For example, the device application matching a particular one of Customer Devices 250 is able to be installed in System 200 to communicate and interact with the corresponding Customer Devices 250 to collect data and provide a service to a user.

The application and service associated with the detected device are registered with the IVI System S1122. Referring to FIG. 2, after a user enters the vehicle, a Local Wireless Communication Service 210 pairs with Customer Devices 250, such as Customer Device A 252, Customer Device B 254, and Customer Device N 256 using wireless communication mechanism, such as Bluetooth and the like. Customer Device A 252 registers with the vehicle at least once.

The detected device is paired with the IVI System S1126. Referring to FIG. 2, the user then uses IVI GUI 220 to pair Customer Device A 252 with System 200. Customer Device A 252 identifies itself to System 200 using certain information. Ideally a communication protocol that devices conform to is used so that when Customer Device A 252 connects, Customer Device A 252 is able to announce the connection in a predetermined format so that the vehicle immediately recognizes what that information represents and how to utilize that information in the execution of existing applications. This provides System 200 the ability to collect different information from multiple devices. This provides System 200 the ability to collect different information from multiple devices. However, according to at least one embodiment, the communication of the information is a function of the application and is limited to a single device. In response to Customer Device A 252 not already being paired with System 200, the IVI GUI 220 is notified by the Local Wireless Devices Services 214 that a new device is ready to be paired. The user then uses IVI GUI 220 to pair Customer Device A 252 with System 200. Customer Device A 252 identifies itself to System 200 using certain information.

Information collected, by the application, from the detected device is received S1130. Referring to FIG. 2, once Customer Device A 252 is paired with System 200, information is collected by the Application 258.

In response to receiving the information, an action for the service is automatically triggered by the IVI System based on the collected information S1134. Referring to FIG. 2, based on the received information, System 200 is able to trigger some type of automation for the convenience and safety of the user.

The service is executed based on the collected information S1138. Referring to FIG. 2, the Customer Services Service 218 executes the application and communicates with the targeted service. Customer Services Service 218 executes the Application 258 and communicates appropriately with a targeted service. Customer Services Service 218 checks whether the Application 258 is compatible with at least one of Customer Devices 250 and with the kind of vehicle associated with the at least one of Customer Devices 250. For example, the Application 258 is to be compatible with the device and also with the vehicle in terms of APIs and the like. For example, Application 258 communicates with Local Wireless Communication Service 210. Local Wireless Communication Service 210 communicates with Local Wireless Devices Service 214. Wireless Devices Service 214 communicates with Customer Services Service 218, wherein Customer Services Service 218 check with Customer Services Registry 212 to determine whether the application has been registered. Upon confirming that the application is registered with Customer Services Registry 212, Customer Services Service 218 sends an automatic trigger to the HVAC Service 224 which communicates with HVAC ECU 260 through Internal Wired Communication Service 1 232 to adjust the temperature.

The process then terminates S1150.

At least one embodiment of the method for provisioning an application to an In-Vehicle Infotainment (IVI) system includes detecting a device in the vehicle, in response to detecting the device in the vehicle, provisioning an application to an IVI system to collect information from the detected device and provide a service to a user based on the collected information, receiving the information collected from the detected device by the application provisioned to the IVI system, and in response to receiving the information, automatically triggering by the IVI system an action for the service based on the information collected by the application from the detected device.

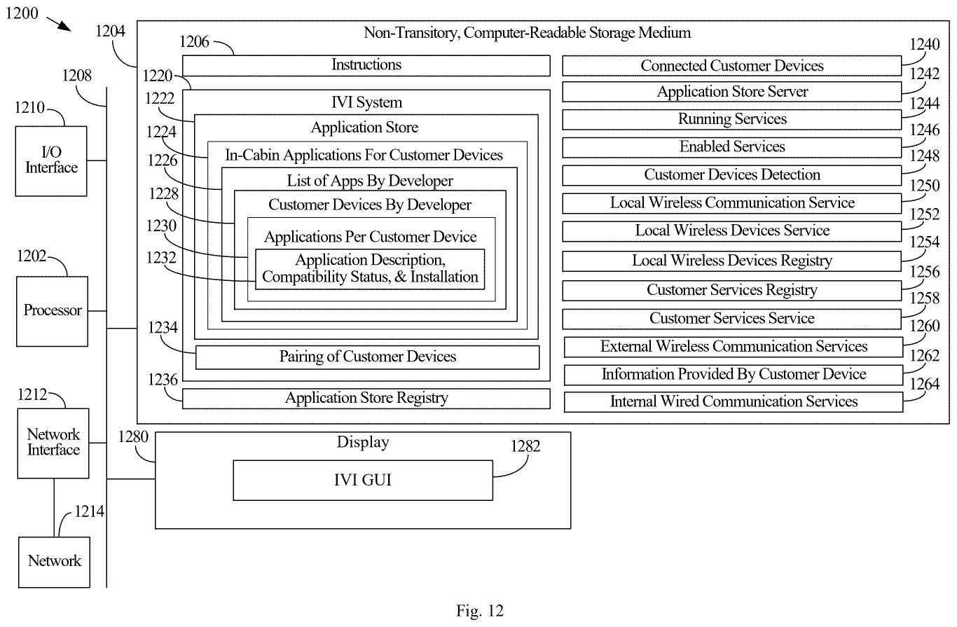

FIG. 12 is a high-level functional block diagram of a processor-based system 1200 according to at least one embodiment.

In at least one embodiment, processing circuitry 1200 detects a user device and provisions an application to an in-vehicle infotainment (IVI) system to provide services to the user based on information collected from the detected device by the application. Processing circuitry 1200 implements a method for detecting a user device and provisioning an application to an IVI system to provide services to the user based on information collected from the detected device by the application using Processor 1202. Processing circuitry 1200 also includes a Non-Transitory, Computer-Readable Storage Medium 1204 that is used to implement method for detecting a user device and provisioning an application to an IVI system to provide services to the user based on information collected from the detected device by the application. Non-Transitory, Computer-Readable Storage Medium 1204, amongst other things, is encoded with, i.e., stores, Instructions 1206, i.e., computer program code, that are executed by Processor 1202 causes Processor 1202 to perform operations for detecting a user device and provisioning an application to an IVI system to provide services to the user based on information collected from the detected device by the application. Execution of Instructions 1206 by Processor 1202 represents (at least in part) an application which implements at least a portion of the methods described herein in accordance with one or more embodiments (hereinafter, the noted processes and/or methods).

Processor 1202 is electrically coupled to Non-Transitory, Computer-Readable Storage Medium 1204 via a Bus 1208. Processor 1202 is electrically coupled to an Input/Output (I/O) Interface 1210 by Bus 1208. A Network Interface 1212 is also electrically connected to Processor 1202 via Bus 1208. Network Interface 1212 is connected to a Network 1214, so that Processor 1202 and Non-Transitory, Computer-Readable Storage Medium 1204 connect to external elements via Network 1214. Processor 1202 is configured to execute Instructions 1206 encoded in Non-Transitory, Computer-Readable Storage Medium 1204 to cause processing circuitry 1200 to be usable for performing at least a portion of the processes and/or methods. In one or more embodiments, Processor 1202 is a Central Processing Unit (CPU), a multi-processor, a distributed processing system, an Application Specific Integrated Circuit (ASIC), and/or a suitable processing unit.

Processing circuitry 1200 includes I/O Interface 1210. I/O interface 1210 is coupled to external circuitry. In one or more embodiments, I/O Interface 1210 includes a keyboard, keypad, mouse, trackball, trackpad, touchscreen, and/or cursor direction keys for communicating information and commands to Processor 1202.

Processing circuitry 1200 also includes Network Interface 1212 coupled to Processor 1202. Network Interface 1212 allows processing circuitry 1200 to communicate with Network 1214, to which one or more other computer systems are connected. Network Interface 1212 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 1200 is configured to receive information through I/O Interface 1210. The information received through I/O Interface 1210 includes one or more of instructions, data, design rules, libraries of cells, and/or other parameters for processing by Processor 1202. The information is transferred to Processor 1202 via Bus 1208. Processing circuitry 1200 is configured to receive information related to a User Interface (UI) through I/O Interface 1210. The information is stored in Non-Transitory, Computer-Readable Storage Medium 1204 as IVI System 1220.

In one or more embodiments, one or more Non-Transitory, Computer-Readable Storage Medium 1204 having stored thereon Instructions 1206 (in compressed or uncompressed form) that may be used to program a computer, processor, or other electronic device) to perform processes or methods described herein. The one or more Non-Transitory, Computer-Readable Storage Medium 1204 includes one or more of an electronic storage medium, a magnetic storage medium, an optical storage medium, a quantum storage medium, or the like.

For example, the Non-Transitory, Computer-Readable Storage Medium 1204 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 1204 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 1204 stores Instructions 1206 configured to cause Processor 1202 to perform at least a portion of the processes and/or methods for detecting a user device and provisioning an application of the In-Vehicle Infotainment (IVI) system to provide services to the user based on information collected from the detected device by the application. In one or more embodiments, Non-Transitory, Computer-Readable Storage Medium 1204 also stores information, such as algorithm which facilitates performing at least a portion of the processes and/or methods for detecting a user device and provisioning an application to an IVI system to provide services to the user based on information collected from the detected device by the application.

Accordingly, in at least one embodiment, Processor 1202 executes Instructions 1206 stored on the one or more Non-Transitory, Computer-Readable Storage Medium 1204 to detect a user device and provision an application to an IVI system to provide services to the user based on information collected from the detected device by the application. Processor 1202 implements Customer Devices Detection 1248 for detecting a Customer Device entering a vehicle. Processor 1202 controls Paring of Customer Devices 1234 with the IVI System 1220. Processor 1202 maintains a Local Wireless Communications Service 1250 to communicate with Connected Customer Devices 1240. Processor 1202 implements a Local Wireless Devices Service 1252 to handle registering of Connected Customer Devices 1240 in Local Wireless Devices Registry 1254. Processor 1202 implements Customer Services Service 1258 for registered customer services of a user in Customer Services Registry 1256. Processor 1202 maintains a list of Connected Customer Devices 1240. Processor 1202 uses Customer Services Service 1258 to monitor the state of customer devices in order to identify Running Services 1244 and Enabled Services 1246. Processor 1202 is able to start or stop Running Services 1244 and Enabled Services 1246. Processor 1202 maintains applications in Application Store Server 1242, wherein applications are registered in Application Store Registry 1236. Processor 1202 uses Customer Services Service 1258 to communicate with External Wireless Communication Services 1260 to access a network 1214, e.g., Internet. Process accesses an Application Store Server 1242 via external wireless Communication Services 1260. Processor 1202 implements different services such as Heating, Ventilation, and Air Conditioning (HVAC) Service, SEAT Service, LIGHTING Service, SOUND Service, and the like. Processor 1202 communicates with Electronic Control Units (ECUs) using Internal Wired Communication Services 1264. Processor 1202 implements IVI System 1220. Processor 1202 uses IVI GUI 1282 of IVI System 1220 to pair customer devices. Processor 1202 presents Application Store GUI 1222 to enable a user to download applications to an IVI system. Through Application Store GUI 1222, Processor 1202 provides access to In-Cabin Applications for Customer Devices GUI 1224. In-Cabin Applications for Customer Devices GUI 1224 provides a List of Apps by Developer 1226. User is able to select Apps from the List of Apps by Developer 1226, wherein Processor presents Customer Devices by Developer 1228. Upon selection of Customer Devices by Developer 1228, Applications per Customer Device GUI 1230 is presented to the user (e.g., Driving While Sleeping Alert, In-Cabin Temperature Adjustment, Relaxing Music while Stressed, and the like). Processor 1202 then presents an Applications Description, Compatibility, and Installation GUI 1232. Processor 1202 is able to present IVI GUI 1282 on Display 1280 for use of IVI System 1220.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for provisioning an application to an In-Vehicle Infotainment (IVI) system in a vehicle, comprising:
detecting a device in the vehicle;
in response to detecting the device in the vehicle, provisioning an application to an IVI system to collect information from the detected device and provide a service to a user based on the collected information;
receiving the information collected from the detected device by the application provisioned to the IVI system; and
in response to receiving the information, automatically triggering by the IVI system an action for the service based on the information collected by the application from the detected device.

2. The method of claim 1, wherein the detecting the device in the vehicle includes:
accessing an applications store;
listing third-party developers of the application in the applications store for selection; and
downloading the application from the applications store to the IVI system.

3. The method of claim 1, wherein the provisioning the application to the IVI system includes:
installing the application on the IVI system; and
pairing the detected device with the IVI system.

4. The method of claim 3, wherein the pairing the detected device with the IVI system includes presenting a status of the pairing of the detected device with the IVI system.

5. The method of claim 3, wherein the installing the application on the IVI system includes registering the application and the service associated with the detected device in a services registry.

6. The method of claim 1, wherein the provisioning the application to the IVI system includes:
providing a description of the service associated with the detected device; and
checking a compatibility of the application with the detected device and with the IVI system.

7. The method of claim 1, wherein the receiving the information collected by the application includes executing the service based on the collected information, and wherein the automatically triggering the action includes communicating with the service associated with the application to provide information for triggering the action.

8. A vehicle information system, comprising:
a memory storing computer-readable instructions; and
a processor connected to the memory, wherein the processor is configured to execute the computer-readable instructions to perform operations to:
detect a device in the vehicle;
in response to detecting the device in the vehicle, provision an application to collect information from the detected device and provide a service to a user based on the collected information;
receive the information collected from the detected device by the application provisioned to collect the information from the detected device; and
in response to receiving the information, automatically trigger an action for the service based on the information collected by the application from the detected device.

9. The vehicle information system of claim 8, wherein the processor is configured to detect the device in the vehicle by:
accessing an applications store;
listing third-party developers of the application in the applications store for selection; and
downloading the device application from the applications store.

10. The vehicle information system of claim 8, wherein the processor is configured to provisioning the device application to the device detected in the vehicle by:
installing the application for communicating with the detected device; and
pairing the detected device with the application.

11. The vehicle information system of claim 10, wherein the processor is configured to pair the detected device by presenting a status of the pairing the detected device with the application.

12. The vehicle information system of claim 10, wherein the processor is configured to install the application by registering the application and the service associated with the detected device in a services registry.

13. The vehicle information system of claim 10, wherein the processor is configured to provision the application by:
providing a description of the service associated with the detected device; and
checking a compatibility of the application with the detected device and with the vehicle.

14. The vehicle information system of claim 8, wherein the processor is configured to receive the information collected by the application by executing the service based on the collected information, and wherein the processor is configured to automatically trigger the action by communicating with the service associated with the application to provide information for triggering the action.

15. A non-transitory computer-readable media having computer-readable instructions stored thereon, which when executed by a processor causes the processor to perform operations comprising:
detecting a device in the vehicle;
in response to detecting the device in the vehicle, provisioning an application to an in-Vehicle Infotainment (IVI) system to collect information from the detected device and provide a service to a user based on the collected information;
receiving the information collected from the detected device by the application provisioned to the IVI system; and
in response to receiving the information, automatically triggering by the IVI system an action for the service based on the information collected by the application from the detected device.

16. The non-transitory computer-readable media of claim 15, wherein the detecting the device in the vehicle includes:
accessing an applications store;
listing third-party developers of the application in the applications store for selection; and
downloading the device application from the applications store to the IVI system.

17. The non-transitory computer-readable media of claim 15, wherein the provisioning the application to the IVI system includes:
installing the application on the IVI system; and
pairing the detected device with the IVI system.

18. The non-transitory computer-readable media of claim 17, wherein the pairing the detected device with the IVI system includes presenting a status of the pairing of the detected device with the IVI system, and wherein the installing the application on the IVI system includes registering the application and the service associated with the detected device in a services registry.

19. The non-transitory computer-readable media of claim 15, wherein the provisioning the device application to the device detected in the vehicle includes:
providing a description of the service associated with the device; and
checking a compatibility of the device application with the device and with the vehicle.

20. The non-transitory computer-readable media of claim 15, wherein the receiving the information collected by the application includes executing the service based on the collected information, and wherein the automatically triggering the action includes communicating with the service associated with the application to provide information for triggering the action.
